(19) United States
(12) Patent Application Publication
(10) Pub. No.: US 2002/0189881 A1
(43) Pub. Date: Dec. 19, 2002

(54) System and method for enhancing vision in a vehicle

(76) Inventors: Larry Mathias, Byron Center, MI (US); Paul R. Amos, Holland, MI (US); Jonathan Peter Cansfield, Holland, MI (US); Eugene J. Sobieski, Holland, MI (US)

Correspondence Address: Steven C Becker, Foley & Lardner, 777 East Wisconsin Avenue, Milwaukee, WI, 53202-5367, US

(21) Appl. No.: 10/169,421

(22) PCT Filed: Jan. 8, 2001
(86) PCT No.: PCT/US01/00439

(51) Int. Cl. B60D 1/28; B60L 3/00; B60R 21/00; B60K 28/00

(52) U.S. Cl. 180/271

(57) ABSTRACT

A vision enhancement system for a vehicle includes a first camera, a second camera, a display, and a switch. The first camera is configured to view an interior of the vehicle and to generate a first video signal representative of the interior of the vehicle. The second camera is configured to view an exterior of the vehicle and to generate a second video signal representative of the exterior of the vehicle. The switch is coupled to the first and second cameras and to the display. The switch is configured to receive the first and second video signals and to selectively provide the first and second video signals to the display.

### CROSS-REFERENCE TO RELATED APPLICATIONS

Not Applicable.

### STATEMENT REGARDING FEDERALLY SPONSORED RESEARCH OR DEVELOPMENT

Not Applicable.

### FIELD OF THE INVENTION

The present invention relates to a vision enhancement system and method for a vehicle, and more particularly, to a vision enhancement system incorporating single or multiple video inputs generated by single or multiple cameras that may include an interior camera, such as, a rear passenger camera, and a camera for viewing the rear of the vehicle.

### BACKGROUND OF THE INVENTION

Rearview and sideview mirror systems are widely used in motor vehicles, such as cars and trucks, to enable the driver to view the rear or side of the vehicle and to monitor the activities of passengers, such as children in the rear seat of a vehicle. Traditionally, rearview mirrors and sideview mirrors are located on the inside of the front windshield and on the sides of a vehicle. All such rearview mirrors and sideview mirrors include a blind spot where the driver cannot accurately view a portion of the area around the vehicle, necessitating the driver to turn his/her head to view the rear portion of the vehicle. Furthermore, in many instances where children are located in the rear seat of a vehicle, it is difficult to monitor the children using a rearview mirror, especially since the rearview mirror has been adjusted for driving and not for viewing the rear seat of a vehicle. In a situation where children are located in the rear seat of a vehicle, a driver must turn his/her head to monitor the behavior of the children. In most traffic conditions, driving a vehicle while trying to view the rear of a vehicle is an awkward task.

Accordingly, there is a need for a rearview vision system that is easily accessed by the driver of a vehicle and can be switched between multiple perspectives of difficult viewing areas in and around a vehicle. Furthermore, there is a need for system and method for viewing the interior of a vehicle to monitor children or other activities within the vehicle. Further still, there is a need for a system and method for improving the quality, visibility, or perspective of images displayed by such systems. Further yet, there is a need for a system and method for improving both audio and visual communication between a front seat passenger and a rear seat passenger in a vehicle. There is also a need for providing convenient and easy-to-use operator controls for such systems. There is also a need for an improved vehicle camera system to provide images of areas in and around the vehicle. The teachings hereinbelow extend to those embodiments which fall within the scope of the appended claims, regardless of whether they accomplish one or more of the above-mentioned needs.

### SUMMARY OF THE INVENTION

According to one exemplary embodiment, a vision enhancement system for a vehicle includes a camera and a display. The camera is coupled to the interior of the vehicle and is configured to view the interior of the vehicle and to generate a video signal representative of the interior of the vehicle. The display is coupled to the interior of the vehicle and coupled to the camera. The display is configured to display the video signal.

According to another exemplary embodiment, a vision enhancement system for a vehicle includes a camera, a display, and a light source. The camera is configured to view an area of the vehicle interior and to generate a video signal representative of the area of the vehicle interior. The display is coupled to the camera and is configured to display the video signal. The light source is positioned proximate the area of the vehicle interior configured to illuminate the area.

According to yet another exemplary embodiment, an integrated audio/visual system for a vehicle includes a vision enhancement system, an audio system, and an operator input device. The vehicle has an interior, and the interior has a front seat and a rear seat. The vision enhancement system includes a camera and a display. The camera is coupled to the interior of the vehicle and is configured to view the interior of the vehicle and to generate a video signal representative of the interior of the vehicle. The display is coupled to the camera and is configured to display the video signal. The audio system is configured to provide an audio signal between a passenger in the front seat and a passenger in the rear seat. An operator input device is coupled to the display and the audio system. The vision enhancement system and the audio system are activated in response to operator input at the operator input device.

According to still another exemplary embodiment, a vision enhancement system for a vehicle includes first and second cameras, a display, and a switch. The first camera is configured to view the interior of the vehicle and to generate a first video signal representative of the interior of the vehicle. The second camera is configured to view the exterior of the vehicle and to generate a second video signal representative of the exterior of the vehicle. The switch is coupled to the first and second cameras and to the display. The switch is configured to receive the first and second video signals and to selectively provide the first and second video signals to the display.

According to another exemplary embodiment, a vision enhancement system for a vehicle includes a rearview camera, a display, and operator input device, and a light source. The rearview camera is configured to generate a video signal representative of an area proximate the rear of the vehicle. The display is coupled to the interior of the vehicle. The light source is coupled to the operator input device and is configured to provide illumination to the area proximate the rear of the vehicle in response to actuation of the operator input device.

According to another exemplary embodiment, a vehicle camera system for a vision enhancement system includes a housing, a camera, and a light source. The camera and light source are both disposed at least partially in the housing. The camera is configured to generate a video signal representative of an area proximate the rear of the vehicle. The light source is configured to provide illumination to the area proximate the rear of the vehicle.

According to another exemplary embodiment, a vision system which incorporates a video display receives video image signals from cameras viewing the interior of a vehicle and cameras viewing the exterior of a vehicle. The video display is placed in an easy to view position with reference to the forward viewing perspective of a driver such that he/she is able to view the video display without significant disruption in operation of the vehicle. In one exemplary embodiment, the video display and controls are incorporated in a bezel mounted in the roof or headliner of a vehicle. The bezel may be mounted in the forward area of a vehicle cabin such as in a position directly above a rearview mirror. The bezel may further include a video camera positioned to view the rear seats of a vehicle.

According to another exemplary embodiment, the video system includes a control interface mounted in the bezel which allows the video display and video inputs to be easily switched by the driver of the vehicle. Light sources remote or proximate the cameras allow dark areas to be illuminated when the driver of a vehicle has switched to a camera viewing the dark areas. For example, when the video display is switched to a camera viewing the rear of the vehicle in a dark or low light condition, a light on the rear of the vehicle will illuminate the area being viewed by the camera. Furthermore, when the video display is switched to the rear seat camera a light positioned proximate the rear seat will automatically illuminate the rear seat.

According to another exemplary embodiment, an audio system is included to allow communication between the driver and passengers in the rear seats of a vehicle. The audio system includes a microphone which responds to the voice of the driver and generates an audio signal. When audio input to the microphone is detected, the audio system will attenuate the signal on the front speakers of a vehicle and switch the rear speakers to the audio signal from the microphone. In this manner, the driver may be clearly heard and understood by passengers in the rear seat of a vehicle.

### BRIEF DESCRIPTION OF THE DRAWINGS

The invention will become more fully understood from the following detailed description, taken in conjunction with the accompanying drawings, wherein like reference numerals refer to like parts, in which:

FIG. 1 is a cutaway perspective view of a vehicle including a video system according to an exemplary embodiment;

FIG. 2 is an overhead view of a vehicle including the video system of FIG. 1;

FIG. 3 is a diagrammatic view of a video control panel according to an exemplary embodiment;

FIG. 4 is a diagrammatic view of an overhead light positioned over a rear seat according to an exemplary embodiment; and

FIGS. 5-7 are views of a vehicle camera system equipped with lights and a video camera according to an exemplary embodiment.

### DETAILED DESCRIPTION OF EXEMPLARY EMBODIMENTS

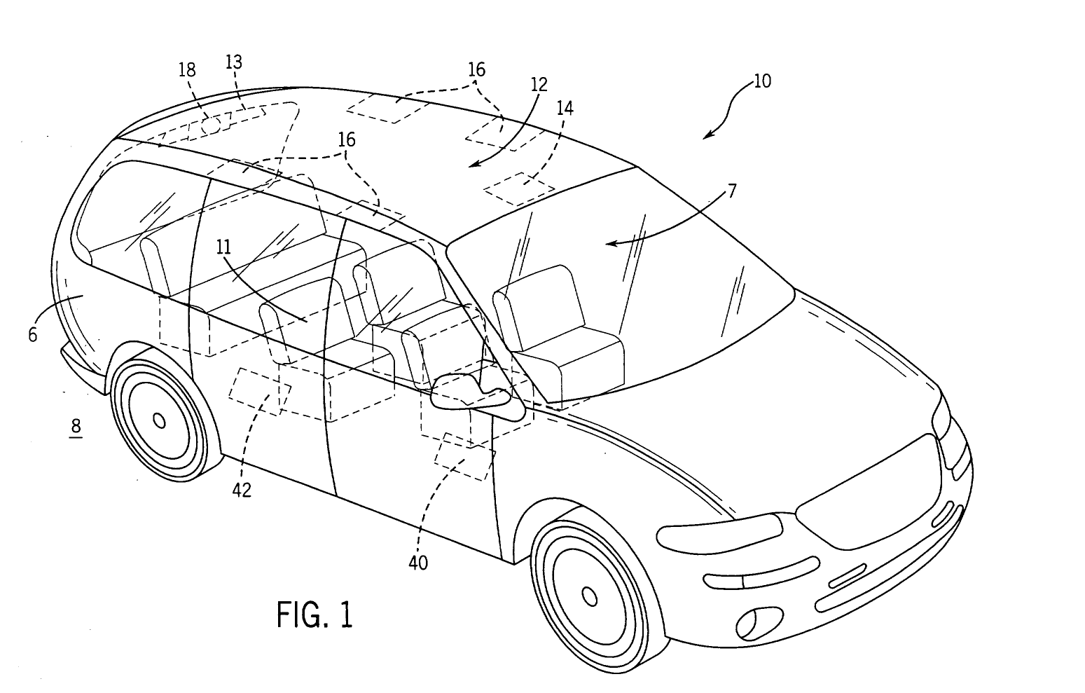

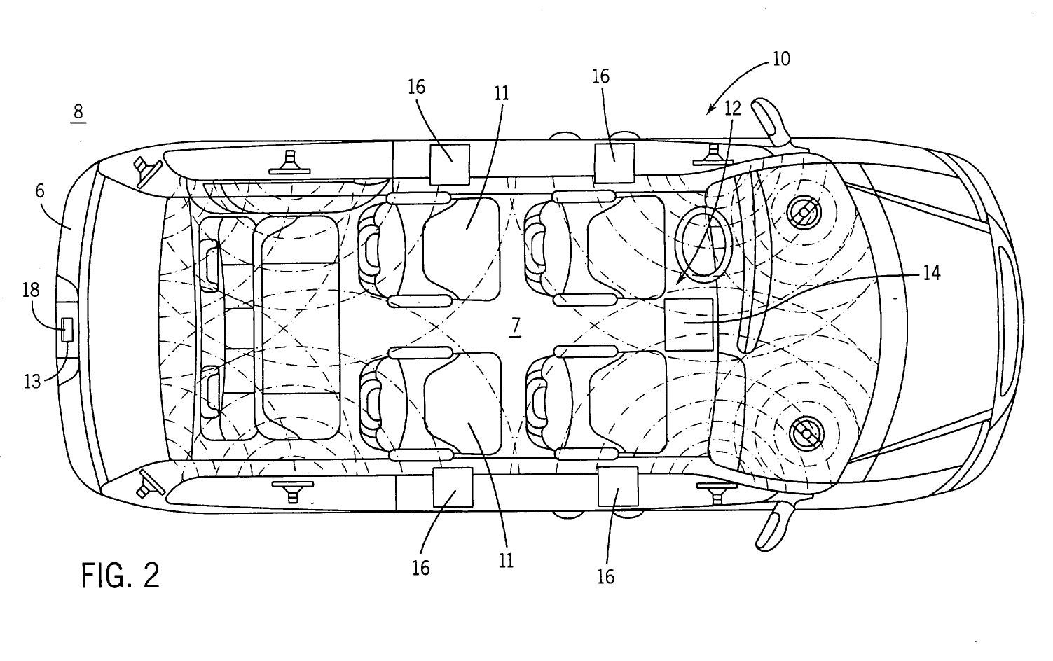

Referring to FIGS. 1, 2, and 3, in accordance with a first embodiment of the present invention, a vehicle 10 is shown equipped with a video system or vision enhancement system 12. Vehicle 10 may be a car, truck, or other vehicle. The vehicle 10 has a rear 6, an interior 7 and an exterior 8, wherein the interior includes front seats 9, rear seats 11, and a chimsel 13. Vehicle exterior 8 generally refers to areas surrounding vehicle interior 7 and/or the exterior surfaces of vehicle 10.

The video system 12 includes a video control panel 14, one or more lights 16 (e.g., rear seat lights), and a camera unit 18 (e.g., a rearview camera unit). The video control panel 14 is preferably mounted in the vehicle 10 cabin in a bezel 17 attached to the roof of the vehicle 10; thus, control panel 14 is mounted in the forward viewing perspective of a driver. The video control panel 14 includes a video display 20 that may be switched from a video input or signal provided by a camera 22 viewing the vehicle interior 7 (e.g., the rear seats 11, other portions of the vehicle interior, etc.) of the vehicle 10 and a video signal provided by the rearview camera unit 18 or another camera unit which views exterior 8 of the vehicle. The video display 20, because of its ergonomic positioning, allows the driver or other front seat passenger of a vehicle to easily view the video display 20 while driving.

An operator input device 24 (e.g., button, switch, dial, clickable icon on display 20, etc.) activates the video display 20 into a default mode wherein the video display 20 receives and displays the video signal from the rearview camera 18. In the preferred embodiment, the video display 20 is a liquid crystal display (“LCD”) with the ability to display analog or digital video inputs, although any video display (e.g., a light-emitting diode (LED) display, a cathode ray tube (CRT), etc.) is considered within the scope of this invention. Thus, cameras 18 and 22 may be any type of digital or analog camera. Video display 20 may be any shape, such as square, rectangular, or elliptical, and may have a surface area of between 8.75 in² and 12 in² or other sizes. Furthermore, the video display 20, in alternate embodiments, may also be electronically configured or reconfigured to display vehicle operation and/or trip data from an onboard controller or computer such as mileage, compass heading, tire pressure, fuel efficiency data, outside/inside temperature, etc., but is not limited to such. Such data may be received from sensors positioned at various locations on the vehicle, and may be received via a wired or wireless connection (e.g., radio frequency, infrared, etc.).

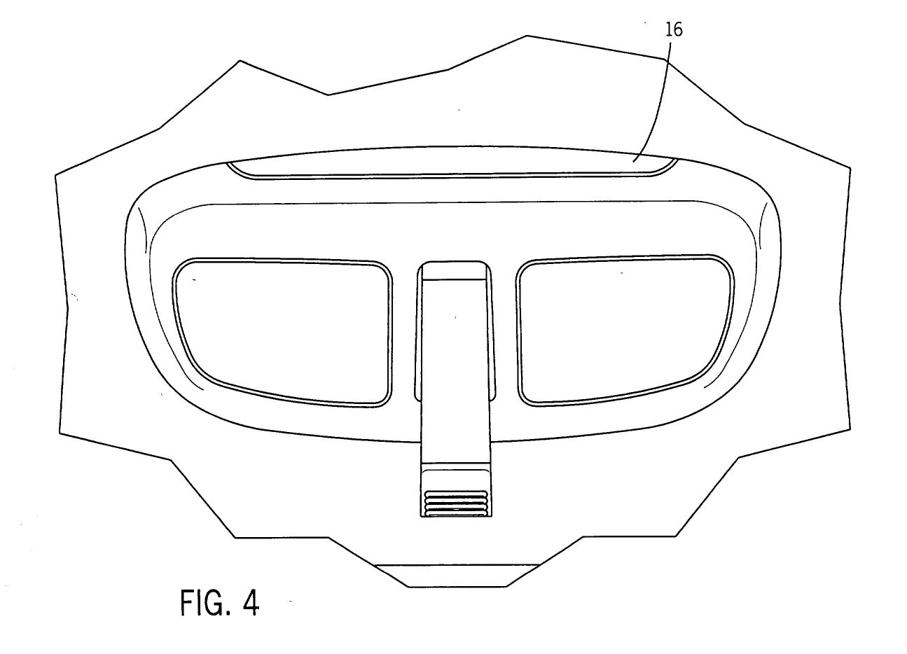

As seen in FIGS. 1-4, the rear seat lights 16 are mounted to the roof of the vehicle 10 proximate the sides of the vehicle 10 and provide ambient light to the rear seats 11 of the vehicle 10 to allow the rear seat camera 22 to provide a well-illuminated picture of the rear seats 11 in low light conditions. Alternatively, lights 16 may be mounted anywhere on vehicle 10, and may be configured to provide illumination to any area of vehicle interior 7 to be viewed by camera 22. Lights 16 may be mounted alone or in a housing or bezel containing one or more of lights 16, a rear speaker for an audio system, a coat hook, and a task light or map light. Lights 16, the rear speaker, and the task light may further have ON/OFF switches associated therewith.

In one embodiment, at least one of the rear seat lights 16 will be automatically turned on when the rear seat camera 22 is switched on using the button 24, but any number or combination of lights 16 switched on is considered within the scope of the present invention. Further, at least one of rear seat lights 16 may be automatically switched off when the rear seat camera 22 is switched off using button 24. A manual override control comprising a pushbutton dial 26 will allow the driver to turn the rear seat lights 16 on and off by pushing the pushbutton dial 26 and will allow the driver to adjust the amount of light generated by the rear seat light by dialing the pushbutton dial 26. In further embodiments, a light sensor may be used to disable the automatic operation of the rear seat light 16 during daylight or high light conditions. The light sensor may include a light sensor circuit comprising the necessary analog or digital logic, software code, etc. to perform the operation of disabling the automatic operation of rear seat light 16.

Lights 16 may include any type of light source, such as fluorescent bulbs, incandescent bulbs, infrared, ultraviolet, a sconce light, an LED, etc. Lights 16 preferably provide a light source easily detectable by camera 22. According to one advantageous feature, the light source provides light in the infrared range. Since infrared light is not visible light, passengers in the rear seats 11, such as children, will not be disturbed or awakened by the presence of the light. Since camera 22 may be configured to detect infrared light, the video signals provided by camera 22 will result in enhanced, easy-to-view images.

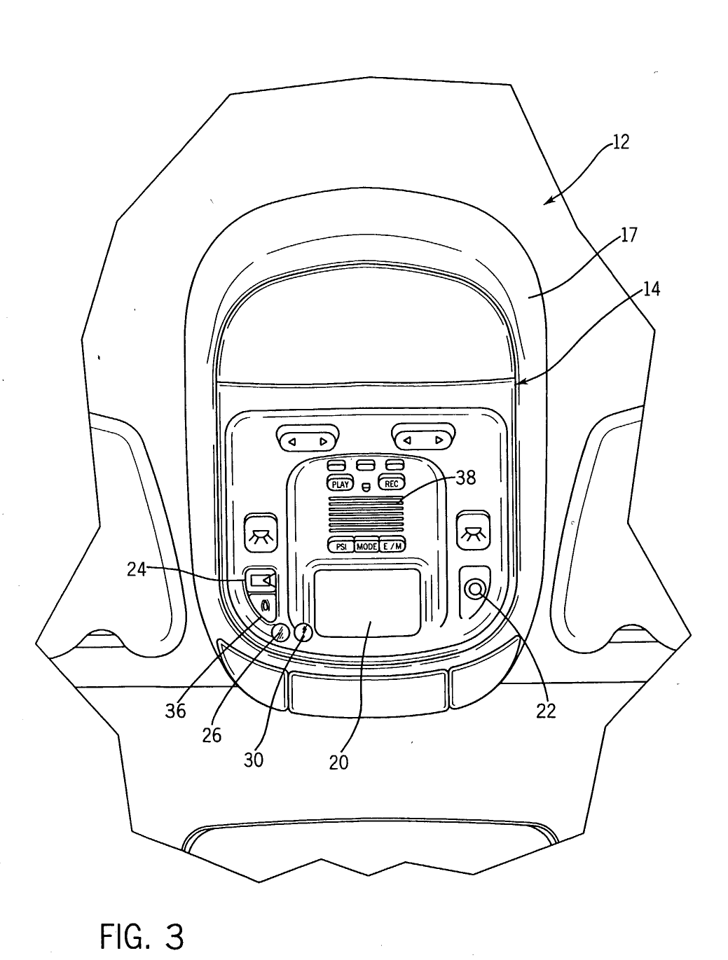

As illustrated in FIG. 3, video control panel 14 includes camera 22 and display 20 mounted in the same bezel or other housing 17. By mounting camera 22 in a forward viewing perspective of the driver of the vehicle, or otherwise in the front of the vehicle, the view of rear seats 11 has a better picture quality (e.g., angle) than if camera 22 were mounted closer to seats 11.

Also, since video control panel 14 is mounted in the roof or headliner in this exemplary embodiment, the video display 20 and microphone 38 are closer to the front seat passengers, such as the driver, for ease of use and clarity of sound.

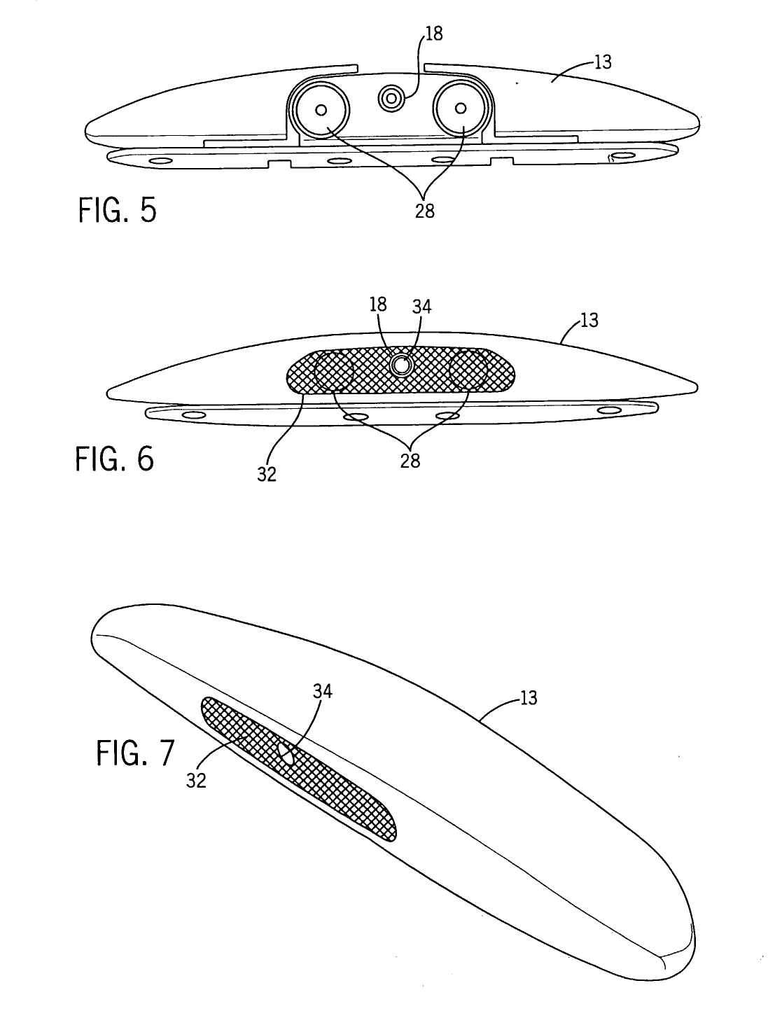

Referring to FIGS. 1, 2, and 5-7, the rearview camera unit 18 is mounted at least partially in a housing 13 (e.g., a chimsel) to provide images below the sightline of a rearview mirror or images normally out of sight of a driver looking towards the rear of the vehicle 10. A chimsel or CHMSL (Center High Mounted Stop Lamp) is a brake light housing mounted to a vehicle in or near an area of the forward visual field toward which a following driver most often glances. The chimsel 13 includes brake lights and the necessary electrical connections to operate the brake lights and the rearview camera unit 18. Advantageously, the rearview camera unit 18 is fully integrated to or fully contained within the chimsel 13 to have an aesthetically appealing physical configuration free of unsightly protrusions normally found in traditional vehicle camera systems.

The rearview camera unit 18 provides video signals that detail the rear area of the vehicle 10. Many objects such as bikes, pets or toys may lie hidden directly below the back of the vehicle 10, producing a situation where the driver may back the vehicle 10 onto such objects. The rearview camera unit 18 enables the driver to view these previously hidden areas or blind spots to avoid such an occurrence. In the preferred embodiment of the present invention, the video signal of the rearview camera unit 18 will automatically be displayed on the video display 20 when the vehicle 10 is placed in reverse via a gearshift lever or other suitable operator input device. The rearview camera unit 18 includes one or more rear lights 28 to illuminate the rear of the vehicle 10 with light directed at the hidden areas or blind spots. Rear lights 28 may include any type of light source, such as fluorescent bulbs, incandescent bulbs, infrared, ultraviolet, sconce lights, LEDs, etc. Lights 28 preferably provide a light source easily detectable by camera 18. The rear lights 28 will be automatically switched on when the vehicle 10 is placed in reverse but may be manually overridden and adjusted by pushbutton dial 30. A light sensor may also be included to disable the rear lights 28 in daylight or in a high light condition. The rearview camera unit 18 further includes a lens 32 to slightly diffuse the light generated by rear lights 28 to allow greater illumination of the rear of the vehicle 10. An aperture or window 34 is formed in the lens 32 to allow the rear camera unit 18 to bypass the interference of the lens 32.

Referring to FIGS. 1 and 3, the video control panel 14 includes various other controls or operator input devices such as an audio system control or input device 36 and a microphone 38. Upon activation of the audio system control 36, audio input generated by a driver or front passenger to the microphone 38 will be measured and compared to a threshold level using a microcontroller or microprocessor. If the audio input is greater than the threshold level, then audio output to front speakers 40 mounted in the vehicle 10 (e.g., from a radio, CD player, or other audio system) will be attenuated (the volume will be reduced) and the audio input to the microphone 38 will be switched to rear speakers 42 mounted in the vehicle 10. In this manner, the voice of a driver will be easily heard by passengers seated in the rear seats 11 of the vehicle 10, via microphone 38 and rear speakers 42.

According to another embodiment, an integrated audio/visual system is provided. A vision enhancement system in one or more of the above-mentioned embodiments is integrated with an audio system. The vision enhancement system includes camera 22, display 20, and an operator input device, such as audio system control 36 or microphone 38. In response to operator input (e.g., a button press, oral command, etc.), the vision enhancement system and the audio system are both activated. For example, camera 22 may begin providing video signals to generate an image on display 20, and microphone 38 may begin transmitting audible signals from a passenger in the front seat to a passenger in the rear seat, or vice-versa, via front- or rear-mounted speakers. Rear-mounted speakers may be provided near lights 16 or in another location near rear seats 11. In this integrated audio/visual system, a single operator input may activate both a video system and an audio system to allow communication between a front seat passenger and a rear seat passenger. Alternatively, if one of the video and audio systems is already activated, the single operator input may activate the other of the video and audio systems. Further, a single operator input may deactivate both the video and audio systems. The activation and deactivation may occur substantially simultaneously.

While the exemplary embodiments illustrated in the Figures and described above are presently preferred, it should be understood that these embodiments are offered by way of example only. For example, while the cameras, speakers, lights and operator input devices are coupled to various portions of the vehicle, alternative locations for these elements are contemplated. Further, the materials and structures shown and described herein may be replaced with other suitable materials and structures. Accordingly, the present invention is not limited to a particular embodiment, but extends to various modifications that nevertheless fall within the scope of the appended claims.

What is claimed:

1. A vision enhancement s)stem for a vehi having an interior and an exterior, comprising:
a camera configured to view the interior of the vehicle and to generate a video signal representative of the interior of the vehicle;
a display configured to display the video signal; and
a computer coupled to the display configured to provide vehicle operation or trip data to the display.

2. The vision enhancement system of claim 1, further comprising:
a second camera configured to view the exterior of the vehicle and to generate a second video signal representative of the exterior of the vehicle; and
a switch coupled to the first and second cameras and to the display, wherein the switch is configured to receive the first and second video signals and to selectively provide the first and second video signals to the display.

3. The vision enhancement system of claim 2, further comprising a button coupled to the switch operable by a driver of the vehicle, wherein the switch is controllable via the button.

4. The vision enhancement system of claim 1, wherein the vehicle operation or trip data includes a compass heading.

5. The vision enhancement system of claim 1, wherein the display is mounted in a headliner of the vehicle.

6. The vision enhancement system of claim 5, wherein the display is mounted directly above a rearview mirror.

7. The vision enhancement system of claim 1, wherein the first camera is mounted in the forward viewing perspective of a driver.

8. The vision enhancement system of claim 1, wherein the first camera is configured to view a rear seat of the vehicle.

9. A method of enhancing vision in a vehicle, comprising:
providing video signals of the interior of the vehicle;
providing vehicle operation or trip data; and
displaying the video signals and the vehicle operation or trip data on a display mounted in the vehicle interior.

10. The method of claim 9, wherein the vehicle operation or tip data includes a compass heading.

11. The method of claim 9, wherein the video signals and the vehicle operation or trip data are displayed simultaneously.

12. The method of claim 9, wherein the display is mounted in a headliner of the vehicle.

13. The method of claim 12, wherein the display is mounted directly above a rearview mirror of the vehicle.

14 The method of claim 9, further comprising:
providing video signals of an area exterior of the vehicle; and
selectively displaying the video signals of the interior of the vehicle and/or the video signals of the exterior of the vehicle in response to the state of a switch.

15. The method of claim 14, further comprising receiving a signal from a user-operable button and selectively displaying the interior and exterior video signals in response to the state of the switch.

16. The method of claim 14, further comprising providing illumination to the area exterior of the vehicle.

17. A vehicle camera system for a vision enhancement system suitable for use with a vehicle having an interior and a rear, comprising:
a chimsel;
a camera disposed at least partially in the chimsel configured to generate a video signal representative of an area proximate the rear of the vehicle; and
a light source disposed at least partially in the chimsel configured to provide illumination to the area proximate the rear of the vehicle.

18. The vehicle camera system of claim 17, further comprising brake lights disposed at least partially in the housing.

19. The vehicle camera system of claim 17, further comprising a gearshift lever, wherein the light source is configured to provide the illumination in response to movement of the gearshift lever into a reverse position.

20. The vehicle camera system of claim 17, wherein the area is a hidden area or a blindspot.

21. The vehicle camera system of claim 20, wherein the light source directs the illumination to the hidden area or blindspot.

22. The vehicle camera system of claim 17, wherein the camera is configured to generate a video signal representative of an area normally out of sight of a driver looking towards the rear of the vehicle.

23. The vehicle camera system of claim 17, wherein the camera is fully contained within the chimsel, wherein the chimsel contains an aperture or window through which the camera acquires a view of the area.

24. The vehicle camera system of claim 17, further comprising a lens configured to slightly diffuse the illumination from the light source.

25. The vehicle camera system of claim 24, wherein the lens includes an aperture or window through which the camera acquires a view of the area.
